(19) United States
(12) Patent Application Publication
(10) Pub. No.: US 2007/0223187 A1
(43) Pub. Date: Sep. 27, 2007

(54) [DETACHABLE FACE PANEL MOUNTING STRUCTURE]

(75) Inventors: Miao-Tzu Chou, TAIPEI (TW); Chia-Yen Hsu, TAIPEI (TW); Chia-Shiang Pua, TAIPEI (TW)

Correspondence Address: DATAVAN INTERNATIONAL CORP., P.O. BOX 108-00403, TAIPEI, TW

(73) Assignee: DATAVAN INTERNATIONAL CORP., Jhonghe City (TW)

(21) Appl. No.: 11/308,417

(22) Filed: Mar. 23, 2006

(51) Int. Cl. G06F 1/16

(52) U.S. Cl. 361/683

(57) ABSTRACT

A detachable face panel mounting structure includes a base frame, which has a flat accommodation chamber, a plurality of mounting grooves extending around the flat accommodation chamber, a face panel accommodated in the flat accommodation chamber, and elastic packing members respectively detachably fastened to the base frame to hold down the face panel in the accommodation chamber, each elastic packing member having a base respectively pressed on the face panel against the base frame and a mounting portion extending from the base and engaged into the mounting grooves of the base frame to seal the gap against dust and water.

### BACKGROUND OF THE INVENTION

1. Field of the Invention

The present invention relates to a face panel mounting structure and more particularly, to a detachable face panel mounting structure, which is detachable and has airtight, waterproof and dustproof characteristics.

2. Description of the Related Art

Following fast development of electronic technology, information industry and network communication technology, information products such as computer, mobile telephone, PDA, and etc., have become the requisites of many people in daily life. A digital information product has a display screen for data output and an input device for data input. From early CRT design to the present LCD design, it is the market tendency to develop products having light, thin, short and small characteristics. With respect to input device, keyboard and mouse are commonly used in information products for data input.

In recent years, touch-panel display has been well developed. A touch-panel display has a touch panel to substitute for a keyboard or mouse for data input. By means of fingers or a touch panel, the user can input instructions through the touch panel. Touch-panel display is intensively used in industrial computers, ATMs (Auto Teller Machines), information inquiry systems, mobile telephones, PDAs (Personal Digital Assistants). A touch panel makes an information product humanized and easy to use.

FIG. 5 is a sectional view of a part of a conventional touch-panel display. As illustrated, a touch-panel display A comprises a housing A2 and a front cover A1. The front cover A1 holds a touch panel B, which is bonded to the front cover A1 with a waterproof glue A11. The housing A2 houses a display module C. The front cover A1 is mounted on a front side of the housing A2. This design of touch-panel display has drawbacks as follows.

1. The touch panel B is operable by hand or with a touch pen. After a long use, the touch panel B may wear. When the touch panel B starts to wear, a maintenance work or replacement of the touch panel B is necessary. However, because the touch panel B is bonded to the front cover A1 with a waterproof glue A11, residual glue will be left and must be well cleaned after dismounting of the touch panel B from the front cover A1. If residual glue is not well cleaned, gaps will exist in between the newly installed touch panel B and the front cover A1, and dust or moisture will penetrate through the gaps into the inside of the touch-panel display A.

2. Except the waterproof glue A11, screws may be used to affix the touch panel B to the front cover A1. During installation, the screws must be properly fastened up. If the screws are fastened excessively tight, the screws may damage the local part of the touch panel B. If the screws are not fastened tight, they may be loosened and may fall from the touch panel B accidentally, causing vibration of the touch panel B.

3. Either a waterproof glue A11 or screws are used to affix the touch panel B to the front cover A1, the maintenance or replacement work of the touch panel B is inconvenient. Only a skilled person can apply to clean the waterproof glue A11 properly. The waterproof glue A11 will leak out of the bonding area between the touch panel B and the front cover A1 if an excessive amount of the waterproof glue A11 is applied. If insufficient amount of the waterproof glue A11 is applied, the touch panel B may drop from the front cover A1 after a long use. Further, when screws are used to substitute for the waterproof glue A11, the user must control the applied force properly, preventing damage to the touch panel B.

### SUMMARY OF THE INVENTION

The present invention has been accomplished under the circumstances in view. According to one aspect of the present invention, the detachable face panel mounting structure comprises a base frame, which has a flat accommodation chamber a plurality of mounting grooves extending around the flat accommodation chamber, a face panel accommodated in the flat accommodation chamber, and elastic packing members respectively detachably fastened to the base frame to hold down the face panel in the accommodation chamber, each elastic packing member having a base respectively pressed on the face panel against the base frame and a mounting portion extending from the base and respectively engaged into the mounting grooves of the base frame to seal the gap against dust and water.

According to another aspect of the present invention, the base frame has a plurality of press portions respectively formed in the mounting grooves for pressing on the mounting portions of the packing member after insertion of the mounting portions into the mounting grooves, and a plurality of retaining portions respectively disposed in the mounting grooves for engaging respective retaining grooves on the mounting portions of the packing members.

### BRIEF DESCRIPTION OF THE DRAWINGS

FIG. 1 is an exploded view of a detachable face panel mounting structure according to the present invention.

FIG. 1A is an enlarged view of part A of FIG. 1.

FIG. 1B is an enlarged view of part B of FIG. 1.

FIG. 2 is an elevational assembly view of the detachable face panel mounting structure according to the present invention.

FIG. 2A is an enlarged view of part A of FIG. 2.

FIG. 2B is an enlarged view of part B of FIG. 2.

FIG. 3 illustrates an application example of the present invention.

FIG. 4 is a sectional view showing an alternate form of the present invention.

FIG. 5 is a sectional view of a part of a conventional touch-panel display.

### DETAILED DESCRIPTION OF THE INVENTION

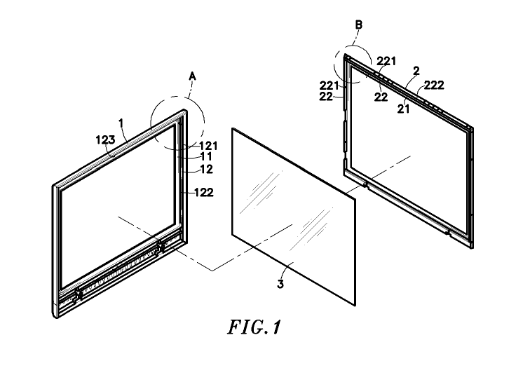

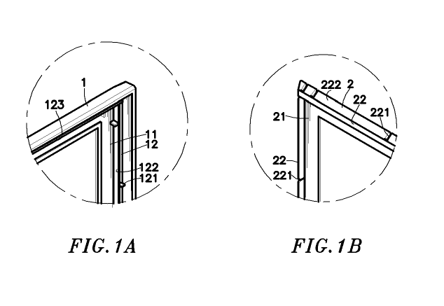

Referring to FIGS. 1, 1A and 1B, a detachable face panel mounting structure in accordance with the present invention is shown comprising a base frame 1, a plurality of packing members 2, and a face panel 3.

The base frame 1 is a flat frame having a flat accommodation chamber 11 adapted to accommodate the face panel 3, a plurality of mounting grooves 12 arranged around the accommodation chamber 11, a plurality of retaining portions 121 and a plurality of press portions 123 respectively formed in the mounting grooves 12, and a beveled guide face 122 formed in each mounting groove 12 at one side. The mounting grooves 12 can be set in parallel or connected at right angles. According to this embodiment, the flat accommodation chamber 11 is formed on a back side of the base frame 1, and the mounting grooves 12 are respectively connected to one another at right angles.

The packing members 2 are arranged corresponding to the mounting grooves 12 of the base frame 1, each having an elongated base 21, a mounting portion 22 extending along the elongated base 21 at one side, a plurality of retaining grooves 221 transversely formed on the mounting portion 22, and a beveled guide face 222 longitudinally formed on the mounting portion 22 at one side and fitting the beveled guide face 122 of the base frame 1. The packing members 2 can be made of silicon rubber, rubber, or any suitable elastic material. The packing members 2 can be arranged in parallel or respectively connected to one another at right angles. According to this embodiment, the packing members 2 are respectively connected to one another, configuring a rectangular open frame.

The face panel 3 can be a transmittance glass, a reinforced glass, or a touch panel made subject to the configuration of the accommodation chamber 11 of the base frame 1.

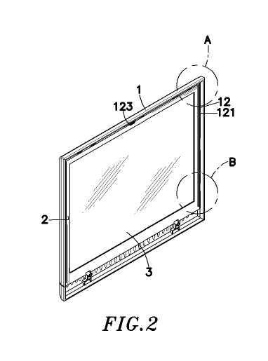

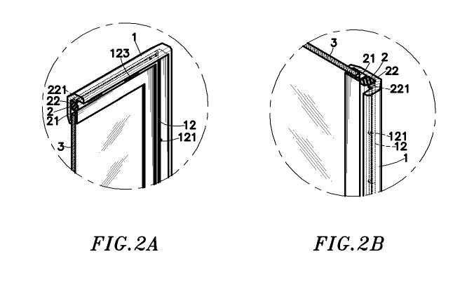

Referring to FIGS. 2, 2A and 2B, and FIG. 1 again, during installation, the face panel 3 is set in the accommodation chamber 11 of the base frame 1, and then the packing members 2 are respectively set in the base frame 1 to hold down the face panel 3. During mounting of each packing member 2, press the base 21 on the face panel 3, and then apply a pressure to the packing member 2 to deform the mounting portion 22 and to further move the beveled guide face 222 of the mounting portion 22 over the corresponding beveled guide face 122 of the base frame 1 so as to force the mounting portion 22 into engagement with the corresponding mounting groove 12 of the base frame 1. At this time, the retaining portions 121 in the associating mounting groove 12 are respectively forced into engagement with the retaining grooves 221 on the mounting portion 22 and the press portions 123 in the associating mounting groove 12 are respectively pressed on mounting portion 22, holding the mounting portion 22 firmly in the corresponding mounting groove 12 of the base frame 1. When installed, the packing members 2 hold the face panel 3 tightly in the accommodation chamber 11 of the base frame 1, and the mounting portions 22 of the packing members 2 are kept engaged into the mounting grooves 12 of the base frame 1 to seal a gap against dust and water.

When detaching the face panel 3 from the base frame 1, apply a pulling force to the packing members 2 to disengage the mounting portions 22 of the packing members 2 from the mounting grooves 12 of the base frame 1. After removal of the packing members 2 from the base frame 1, the face panel 3 can be directly removed from the base frame 1.

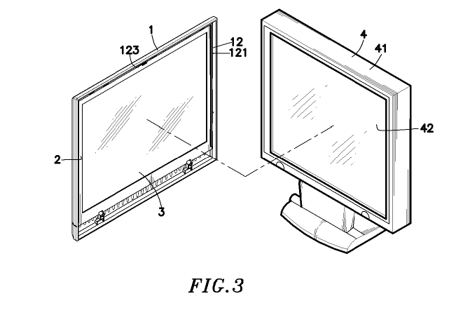

FIG. 3 illustrates an application example of the present invention. As illustrated, the face panel mounting structure of the present invention is mounted on a housing 41 of a LCD monitor 4, holding the face panel 3 on a front side of a display screen 42 of the LCD monitor 4. According to this application example, the face panel 3 is a touch panel for inputting instructions.

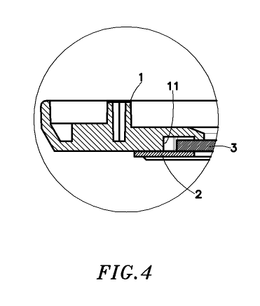

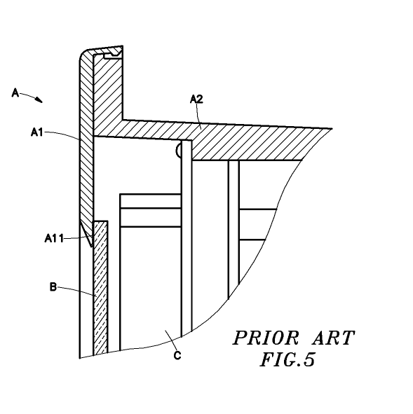

Referring to FIG. 4 and FIG. 3 again, the flat accommodation chamber 11 is formed on a front side of the base frame 1, and the packing members 2 are fastened to the base frame 1 to hold down the face panel 3 in the flat accommodation chamber 11 at the front side of the base frame 1. According to this embodiment, the user can detach the face panel 3 from the base frame 1 without detaching the base frame 1 from the housing 41 of the LCD monitor 4.

In comparison with the conventional design, the detachable face panel mounting structure has the following advantages.

1. By means of engaging the mounting portions 22 of the packing members 2 into the mounting grooves 12 of the base frame 1, the packing members 2 hold down the face panel 3 firmly in the base frame 1. By means of applying a pulling force to the packing members 2, the packing members 2 can easily and quickly be detached from the base frame 1 for replacement or repair of the face panel 3. Therefore, the invention allows quick detachment and re-installation, eliminating the drawback of complicated replacement procedure of the prior art design.

2. The mounting portions 22 of the packing members 2 are squeezed to deform and then forced into engagement with the mounting grooves 12 of the base frame 1 to seal a gap against dust and water. When installed, the base 21 of each packing member 2 is pressed on the surface of the face panel 3. This design presents formation of a local stress on the face panel 3 as encountered in the prior art design that uses screws to affix the face panel 3. Further, the invention eliminates the procedure of sealing the gap with a layer of waterproof glue as employed in the prior art design.

3. When repairing or replacing the face panel 3, the packing members 2 can be directly detached from the base frame 1 without any tools. After removal of the face panel 3 from the base frame 1, the user needs not to clean the base frame 1 because no residual glue is left in the base frame 1.

A prototype of detachable face panel mounting structure has been constructed with the features of FIGS. 1-4. The detachable face panel mounting structure functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A detachable face panel mounting structure comprising:
a base frame, said base frame defining a flat accommodation chamber at one side thereof and a plurality of mounting grooves respectively extending around said flat accommodation chamber;
a face panel accommodated in said flat accommodation chamber; and
a plurality of packing members respectively fastened to said base frame to hold down said face panel in said accommodation chamber, said packing members each having a base respectively pressed on said face panel against said base frame, and a mounting portion extending from said base and respectively engaged into said mounting grooves of said base frame.

2. The detachable face panel mounting structure as claimed in claim 1, wherein said flat accommodation chamber and said mounting grooves are formed on a front side of said base frame.

3. The detachable face panel mounting structure as claimed in claim 1, wherein said flat accommodation chamber and said mounting grooves are formed on a back side of said base frame.

4. The detachable face panel mounting structure as claimed in claim 1, wherein said mounting grooves of said base frame include at least two mounting grooves that are arranged in parallel.

5. The detachable face panel mounting structure as claimed in claim 1, wherein said mounting grooves of said base frame include at least two mounting grooves that are connected at right angles.

6. The detachable face panel mounting structure as claimed in claim 1, wherein said mounting grooves of said base frame each have a beveled guide face disposed at one side for guiding the mounting portions of said packing members into said mounting grooves respectively.

7. The detachable face panel mounting structure as claimed in claim 6, wherein said packing members each have a beveled guide face longitudinally formed on the respective mounting portion at one side and fitting the beveled guide face in each of said mounting grooves of said base frame.

8. The detachable face panel mounting structure as claimed in claim 1, wherein said base frame has a plurality of press portions respectively formed in said mounting grooves for pressing on the mounting portions of said packing member after insertion of said mounting portions into said mounting grooves.

9. The detachable face panel mounting structure as claimed in claim 1, wherein said packing members each have at least one retaining groove transversely formed on said mounting portions; said base frame has a plurality of retaining portions respectively disposed in said mounting grooves for engaging the retaining grooves on the mounting portions of said packing members.

10. The detachable face panel mounting structure as claimed in claim 1, wherein said packing members are made of an elastic material.

11. The detachable face panel mounting structure as claimed in claim 10, wherein said elastic material is rubber.

12. The detachable face panel mounting structure as claimed in claim 10, wherein said elastic material is silicon rubber.
